(19) United States
(12) Patent Application Publication
(10) Pub. No.: US 2022/0083576 A1
(43) Pub. Date: Mar. 17, 2022

(54) INFORMATION PROCESSING SYSTEM AND NON-TRANSITORY COMPUTER READABLE MEDIUM

(71) Applicant: FUJIFILM BUSINESS INNOVATION CORP., Tokyo (JP)

(72) Inventor: Yui SAKATA, Kanagawa (JP)

(73) Assignee: FUJIFILM BUSINESS INNOVATION CORP., Tokyo (JP)

(21) Appl. No.: 17/176,715

(22) Filed: Feb. 16, 2021

(30) Foreign Application Priority Data
Sep. 17, 2020 (JP) 2020-156618

(51) Int. Cl. G06F 16/332; G06F 16/38; G06F 16/338; G06F 16/35

(52) U.S. Cl. CPC G06F 16/3323; G06F 16/355; G06F 16/338; G06F 16/38

(57) ABSTRACT

An information processing system includes a processor configured to receive entry of an attribute given to a document as a search key for searching for a document, and search for the document by using a representative value of a group including plural first attributes having similar meanings as elements thereof in a case where the received search key includes any one of the first attributes, a second attribute being set as the representative value of the group.

### CROSS-REFERENCE TO RELATED APPLICATIONS

This application is based on and claims priority under 35 USC 119 from Japanese Patent Application No. 2020-156618 filed Sep. 17, 2020.

### BACKGROUND

### (i) Technical Field

The present disclosure relates to an information processing system and a non-transitory computer readable medium.

### (ii) Related Art

In some document management systems, a user can give any attribute name. In this case, term inconsistency among attribute names tends to appear, for example, among different users because the users can freely give attribute names. As a result, similar attribute names are created. This term inconsistency is eliminated, for example, manually or by replacement with another attribute name by the management system.

See, for example, Japanese Unexamined Patent Application Publication 2008-310626.

### SUMMARY

Although the term inconsistency is eliminated by replacement with another attribute name, if an attribute name before the replacement is lost, such a situation can occur in which a user who does not know the replacement cannot find out a target document by a search using an attribute name which the user gave.

Aspects of non-limiting embodiments of the present disclosure relate to a technique for allowing a user to find a target document by a search using an attribute which the user gave even after unification of similar attributes into a representative value.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to receive entry of an attribute given to a document as a search key for searching for a document, and search for the document by using a representative value of a group including plural first attributes having similar meanings as elements thereof in a case where the received search key includes any one of the first attributes, a second attribute being set as the representative value of the group.

### BRIEF DESCRIPTION OF THE DRAWINGS

Exemplary embodiments of the present disclosure will be described in detail based on the following figures, wherein:

FIG. 1 schematically illustrates an example of an overall configuration of a document management system used in the first exemplary embodiment;

FIG. 2 is a view for explaining an example of a hardware configuration of a shared server used in the first exemplary embodiment;

FIG. 3 is a view for explaining some of functions realized by a processor;

FIG. 4 is a view for explaining an example of a configuration of a document DB;

FIG. 5 is a view for explaining an example of an attribute group stored in an attribute group DB;

FIG. 6 illustrates an example of a structure of an attribute group;

FIG. 7 is a flowchart for explaining an example of processing operation concerning registration of an attribute group performed by the shared server used in the first exemplary embodiment;

FIG. 8 is a view for explaining a relationship between a folder and an attribute group after grouping processing according to the first exemplary embodiment;

FIG. 9 is a flowchart for explaining an example of processing operation concerning a search for a document performed by the shared server used in the first exemplary embodiment;

FIG. 10 is a view for explaining an example of a process of conducting a search according to the first exemplary embodiment;

FIG. 11 is a flowchart for explaining an example of grouping processing in processing operation concerning registration of an attribute group performed by a shared server used in the second exemplary embodiment;

FIG. 12 is a view for explaining a state of a middle stage of the grouping processing according to the second exemplary embodiment;

FIG. 13 is a view for explaining a state after completion of the grouping processing according to the second exemplary embodiment;

FIG. 14 is a flowchart for explaining an example of processing operation concerning a search for a document performed by the shared server used in the second exemplary embodiment;

FIG. 15 is a view for explaining a process of conducting a search according to the second exemplary embodiment;

FIG. 16 is a flowchart for explaining an example of grouping processing in processing operation concerning registration of an attribute group performed by a shared server used in the third exemplary embodiment;

FIG. 17 is a view for explaining a state after completion of the grouping processing according to the third exemplary embodiment;

FIG. 18 is a view for explaining a display example of attributes of a document according to the exemplary embodiment;

FIG. 19 is a view for explaining some of functions realized by a processor of a shared server used in the fourth exemplary embodiment;

FIG. 20 is a view for explaining an example of a configuration of a document DB;

FIG. 21 is a view for explaining an example of generation of an attribute group according to the fourth exemplary embodiment;

FIG. 22 is a flowchart for explaining an example of grouping processing in processing operation concerning registration of an attribute group performed by a shared server used in the fourth exemplary embodiment;

FIGS. 23A and 23B are views for explaining a relationship between plural attribute groups, FIG. 23A illustrates a relationship in which one attribute group includes the whole other attribute group, and FIG. 23B illustrates a relationship in which one attribute group partially overlaps the other attribute group but one attribute group does not include the other attribute group;

FIG. 24 illustrates an example of a structure of an attribute group in a case where there is another attribute group having the same priority;

FIG. 25 is a view for explaining some of functions realized by a processor of a shared server used in the fifth exemplary embodiment; and

FIG. 26 illustrates an example of a screen of attribute names displayed on a display of a user terminal when a new document is registered.

### DETAILED DESCRIPTION

Exemplary embodiments of the present disclosure are described below with reference to the drawings.

### First Exemplary Embodiment

### Configuration of System

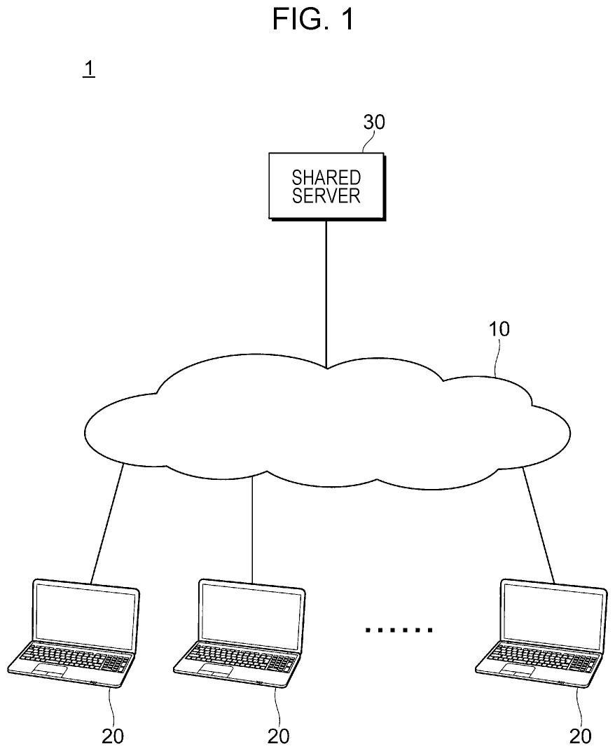

FIG. 1 schematically illustrates an example of an overall configuration of a document management system 1 used in the first exemplary embodiment.

The document management system 1 illustrated in FIG. 1 includes a network 10, a user terminal 20 operated by a user using the system, and a shared server 30 used for sharing of documents.

Examples of a document in the present exemplary embodiment include an office document created by office software or any of other application programs, an e-mail, image data optically read from a document, a facsimile document, a photograph, accounting data, medical data, and a database. A document in the present exemplary embodiment can be any document that can be shared by plural users. Note that examples of an image-form document include not only a still image but also a moving image.

The network 10 is, for example, a local area network (LAN) or the Internet. The network 10 may be a combination of a LAN and the Internet.

The user terminal 20 is, for example, a notebook computer, a desktop computer, a tablet computer, a smartphone, or an image forming apparatus and is used to upload or download a document to or from the shared server 30.

Each user terminal 20 has a motherboard on which circuits for processing data are integrated, a storage in which data is stored, a display used to display information, a touch panel and/or a keyboard used to enter information, and a communication module used for communication with the network 10.

On the motherboard, for example, a processor, a random access memory (RAM) used as a region for execution of a program, and a read only memory (ROM) in which a Basic Input/Output System (BIOS) and the like are stored are provided.

The image forming apparatus assumed in the present exemplary embodiment has not only a function of printing an image on a sheet, but also a function of optically reading an image from a document or the like and a function of facsimile communication. This kind of image forming apparatus is also call a multifunction printer. Note that the above functions of the image forming apparatus are merely examples, and the image forming apparatus may have other functions.

The storage is a hard disk or a non-volatile rewritable semiconductor memory.

Although plural user terminals 20 are illustrated in FIG. 1, the number of user terminals 20 may be one.

The shared server 30 offers a cloud service that supports sharing of documents. Although a single shared server 30 is illustrated in FIG. 1, the shared server 30 may be plural servers that are physically apart from one another. For example, the shared server 30 may be a cloud server. The shared server 30 may be an on-premise server.

The shared server 30 according to the present exemplary embodiment is an example of an information processing system.

Configuration of Shared Server

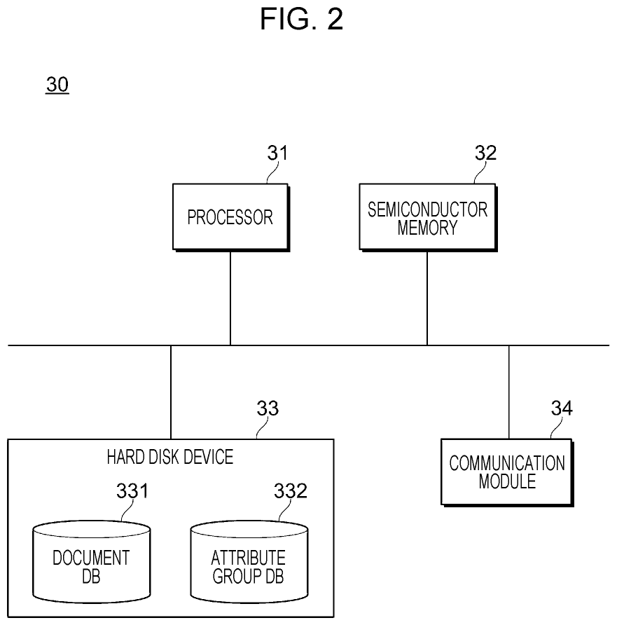

FIG. 2 is a view for explaining an example of a hardware configuration of the shared server 30 used in the first exemplary embodiment.

The shared server 30 has a processor 31 that controls operation of the whole device, a semiconductor memory 32, a hard disk device 33, and a communication module 34, which are connected through a signal line or a bus.

The processor 31 realizes various functions through execution of programs. The processor 31 in the present exemplary embodiment offers, for example, a document search service using an attribute name.

The semiconductor memory 32 is constituted, for example, by a ROM and a RAM. The RAM is an example of a first storage device.

The processor 31 and the semiconductor memory 32 constitute a computer.

The communication module 34 is, for example, an Ethernet (Registered Trademark) module, a module for a wireless LAN, or a module for a fifth-generation mobile communication system (5G).

The hard disk device 33 is an example of an auxiliary storage device. For example, an operating system and application programs are stored in the hard disk device 33. A large-capacity semiconductor memory may be used instead of the hard disk device 33.

The hard disk device 33 in the present exemplary embodiment stores therein a document database (hereinafter referred to as a “document DB”) 331 in which documents to be shared are stored and an attribute group database (hereinafter referred to as an “attribute group DB”) 332 in which a group of attribute names having similar meanings among attributes given to documents is managed.

An attribute name is used in combination with a corresponding attribute value. The attribute name is an example of an attribute.

The attribute name gives a property of an attribute or a kind of attribute. Examples of the attribute name include a “file name”, a “creator”, a “date of creation”, a “destination”, and an “approval status”.

The attribute value is a specific value corresponding to the attribute name. Examples of the attribute value include “ABC proposal”, “TARO FUJI”, “Aug. 30, 2020”, “XYZ system”, and “approved”.

The attribute group DB 332 in the present exemplary embodiment is a database in which a group of attribute names having similar meanings is managed. Plural attribute names having similar meanings appear because a user can enter a free word as an attribute name. There is term inconsistency among attribute names having similar meanings. Note that the similarity of meanings is not limited to similarity in expression and similarity of meanings written in a general dictionary and encompasses similarity based on common knowledge in a specific kind of business or a specific field of business.

An individual attribute group that constitutes the attribute group DB 332 is given a representative value of attribute names.

In the present exemplary embodiment, the attribute group DB 332 is used to search the document DB 331 for a document. In the present exemplary embodiment, a directory in which documents are stored in a case where documents are managed in a hierarchical way is used as a unit for management of similar attribute names.

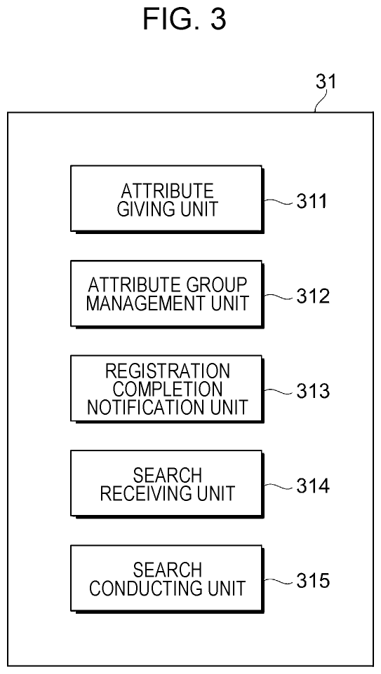

FIG. 3 is a view for explaining some functions realized by the processor 31. FIG. 3 illustrates, as some functions realized by the processor 31, an attribute giving unit 311, an attribute group management unit 312, a registration completion notification unit 313, a search receiving unit 314, and a search conducting unit 315. These functions are realized by execution of programs by the processor 31.

The attribute giving unit 311 realizes a function of giving an attribute name to a document stored in the shared server 30 (see FIG. 1) in accordance with an instruction from the user terminal 20 (see FIG. 1).

A user who operates the user terminal 20 can freely designate an attribute name. For this reason, term inconsistency occurs. In the present exemplary embodiment, there is no limit on the number of attribute names given to a single document.

An attribute name may be given to a document by an operating system or an application program.

The attribute group management unit 312 is a function of managing a group (hereinafter referred to as an “attribute group”) of attribute names having similar meanings among attribute names given to documents stored in the document DB 331 (see FIG. 2).

The attribute group may be manually generated by a user or may be generated by the operating system or an application program in accordance with a predetermined rule. The attribute group management unit 312 generates an attribute group, for example, in accordance with a predetermined schedule.

In the present exemplary embodiment, an attribute group is generated on a folder (i.e., directory) basis. That is, in the present exemplary embodiment, a folder at one level is used as the unit, but plural folders that are in a parent-child relationship or a brother relationship may be used as the unit. Note that the attribute group may be managed irrespective of the parent-child relationship or the like. The parent-child relationship is a relationship between an upper node and a lower node in a case where a tree structure is used for management of documents. Meanwhile, the brother relationship is a relationship between plural lower nodes having a common upper node.

The attribute group DB 332 in the present exemplary embodiment has a schema-less structure in which an attribute group, a representative value of the attribute group, and a location of a folder corresponding to the attribute group are associated.

The registration completion notification unit 313 realizes a function of issuing a notification prompting a user to check a result of processing when grouping of attribute names is completed.

The search receiving unit 314 realizes a function of receiving a search for a document stored in the shared server 30 (see FIG. 1). A search query is given from the user terminal 20 (see FIG. 1). The search query includes, for example, one or more search terms. The search term in the present exemplary embodiment is an attribute name. The search term is an example of a search key.

The search receiving unit 314 also acquires information such as information for specifying a user who gives an instruction to conduct a search, time and date of the instruction to conduct a search, and information on a search query from the user terminal 20 and stores therein the acquired information.

The search conducting unit 315 realizes a function of searching for a document that meets a designated search query and supplies a result of the search to the user terminal 20.

### Example of Document DB

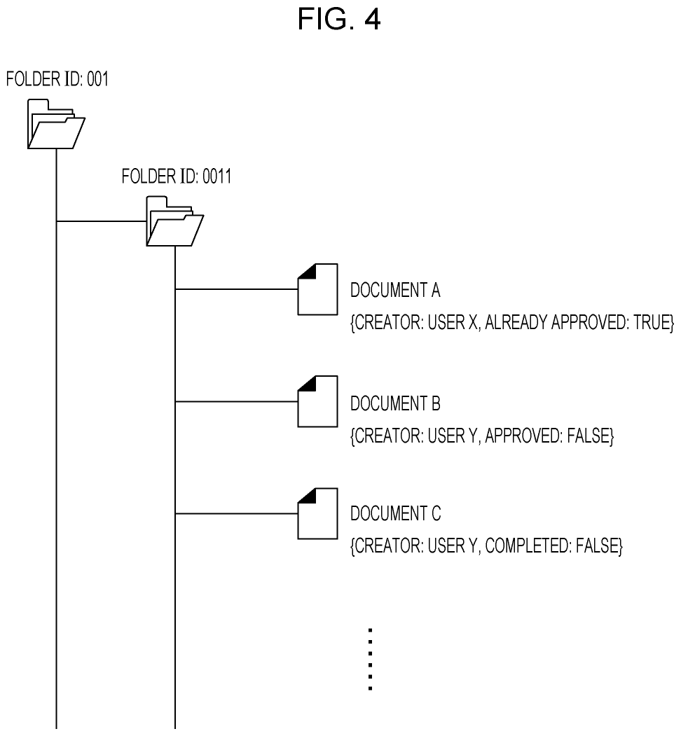

FIG. 4 is a view for explaining an example of a configuration of the document DB 331 (see FIG. 2). The document DB 331 used in the present exemplary embodiment stores therein documents in association with folders corresponding to nodes of a tree structure.

Each folder is given an identifier (ID).

In FIG. 4, an ID of a folder located at a root is “001”, and an ID of a folder corresponding to a child node of the root is “0011”.

The folder located at the root is a folder having no parent node. The folder corresponding to the child node is a folder located at a level lower than the folder at the root. Although the child node is located at the first level from the root in FIG. 4, the child node may be located at the second or subsequent level. Although a single child node is illustrated in FIG. 4, plural child nodes may be provided.

In the present exemplary embodiment, an ID is, for example, used for association with an attribute group.

In FIG. 4, plural documents are stored in the folder identified by the ID “0011”. In FIG. 4, a document A, a document B, and a document C are illustrated as an example of the plural documents.

Attribute names “CREATOR” and “ALREADY APPROVED” are given to the document A.

An attribute value corresponding to “CREATOR” is “USER X”. An attribute value corresponding to “ALREADY APPROVED” is “TRUE”. “TRUE” indicates an approved state.

Attribute names “CREATOR” and “APPROVED” are given to the document B. An attribute value corresponding to “CREATOR” is “USER Y”. The attribute name “APPROVED” given to the document B by the user Y and the attribute name “ALREADY APPROVED” given to the document A by the user X have the same meaning but use different terms. “APPROVED” and “ALREADY APPROVED” are an example of term inconsistency. In the case of the document B, an attribute value corresponding to “APPROVED” is “FALSE”. “FALSE” indicates an unapproved state.

Attribute names “CREATOR” and “COMPLETED” are given to the document C. An attribute value corresponding to “CREATOR” is “USER Y”. The attribute name “COMPLETED” given to the document C by the user Y also has the same meaning but uses a different term from the attribute name “ALREADY APPROVED” given to the document A by the user X and the attribute name “APPROVED” given to the document B by the user Y. “ALREADY APPROVED”, “APPROVED”, and “COMPLETED” are an example of attribute names having similar meanings.

An attribute value corresponding to “COMPLETED” is “FALSE”.

Although only documents given attribute names having similar meanings are illustrated in the example of FIG. 4, not all attribute names belonging to the same folder are similar. For example, “CREATOR” and “ALREADY APPROVED” do not have similar meanings.

Although each document is given two attribute names in the example of FIG. 4, the number of attribute names given to each document may be one or may be three or more.

### Example of Attribute Group DB

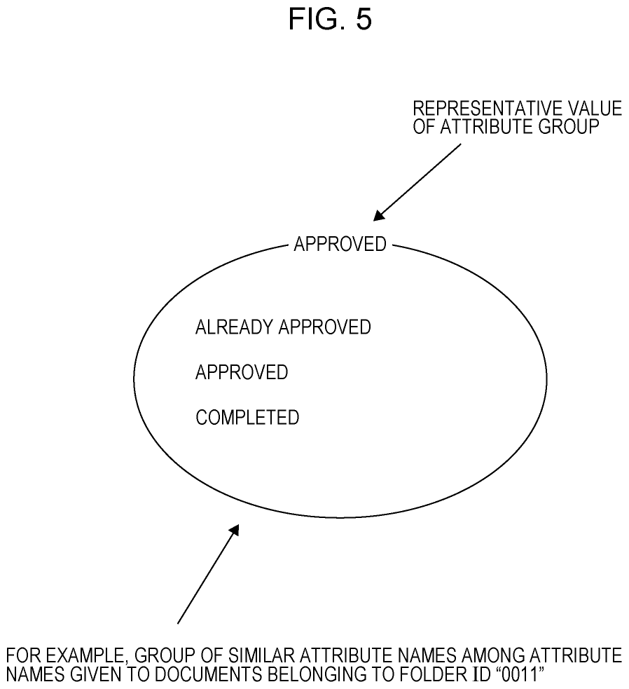

FIG. 5 is a view for explaining an example of an attribute group stored in the attribute group DB 332 (see FIG. 2).

The attribute group illustrated in FIG. 5 is a group of attribute names having similar meanings among the attribute names given to the documents belonging to the folder ID “0011” illustrated in FIG. 4. Accordingly, the attribute group includes “ALREADY APPROVED”, “APPROVED”, and “COMPLETED” described above as elements thereof. “ALREADY APPROVED”, “APPROVED”, and “COMPLETED” are an example of first attributes.

In FIG. 5, “APPROVED” is designated as a representative value of the three attribute names belonging to the same attribute group. “APPROVED” as a representative value is an example of a second attribute. Although the representative value is identical to one of the attribute names that are the elements of the attribute group in FIG. 5, the representative value is not necessarily identical to one of the attribute names that are the elements of the attribute group.

In the present exemplary embodiment, the representative value is designated by a user. Note, however, that the representative value may be given by the operating system or an application program.

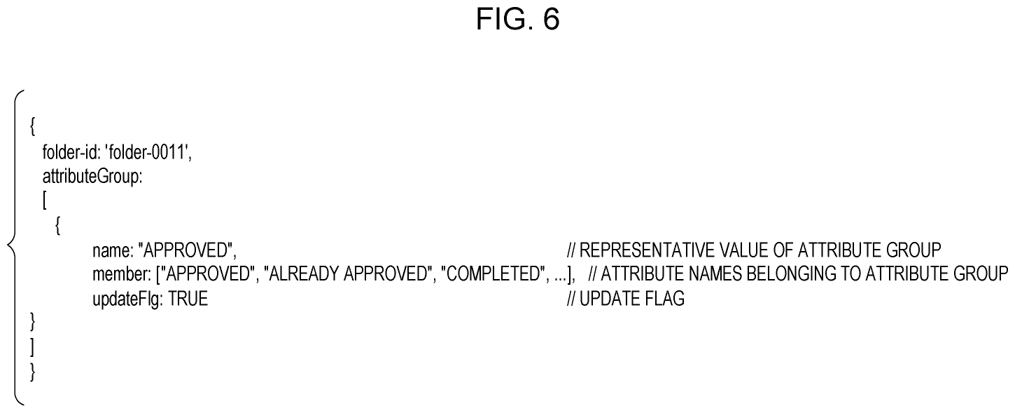

FIG. 6 illustrates an example of a structure of the attribute group. In the example of FIG. 6, the attribute group whose representative value is “APPROVED” is illustrated.

In the case of FIG. 6, “APPROVED”, “ALREADY APPROVED”, and “Completed” are illustrated as attribute names belonging to the attribute group. An update flag of the attribute group is set to “TRUE”.

The update flag in the present exemplary embodiment indicates whether or not execution of grouping processing is needed.

“TRUE” indicates that grouping processing is necessary and is used, for example, in a case where the representative value is changed, a case where the number of attribute names that are elements is increased or decreased, or a case where contents of the attribute names that are the elements are changed. In other words, the update flag is set to “TRUE” in a case where a change is made to the attribute group.

In the present exemplary embodiment, management of the attribute group is executed regularly, for example, at 1 a.m. every day. When the grouping processing is finished, the update flag is changed from “TRUE” to “FALSE”.

In a case where the update flag is “TRUE”, the attribute group is subjected to the grouping processing performed by the attribute group management unit 312. In the grouping processing, an attribute group to which attribute names belong and documents given the attribute names that are elements of the attribute group are associated. Meanwhile, in a case where the update flag is “FALSE”, the attribute group is excluded from a target of the grouping processing performed by the attribute group management unit 312.

### Processing Operation

### Registration of Attribute Group

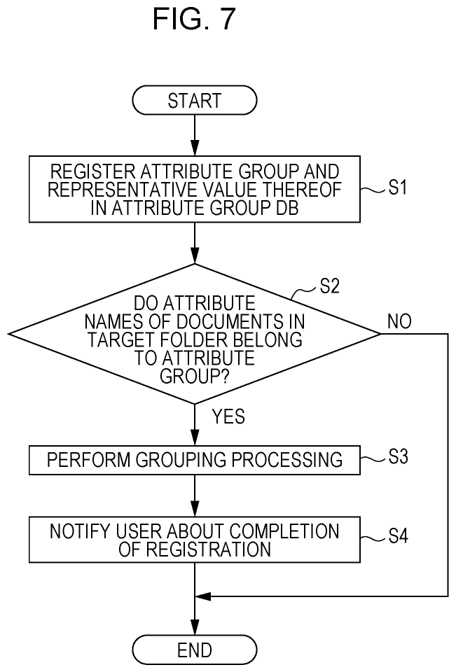

FIG. 7 is a flowchart for explaining an example of processing operation concerning registration of an attribute group performed by the shared server 30 (see FIG. 1) used in the first exemplary embodiment. In FIG. 7, the symbol “S” represents a step.

Note that the processing operation illustrated in FIG. 7 is performed by the processor 31 (see FIG. 2).

The processor 31 registers an attribute group and a representative value thereof in the attribute group DB 332 (see FIG. 2) (step 1).

In the present exemplary embodiment, a representative value of an attribute group and attribute names that are elements of the attribute group are designated by a user using the service or an administrator who has an authority of registration (hereinafter referred to as a “user or the like”).

The registration includes not only new registration but also a change to an existing attribute group.

Next, the processor 31 determines whether or not attribute names of documents in a target folder belong to the attribute group (step 2).

In a case where an attribute name of a document is not included in the elements of the attribute group registered in step 1, the processor 31 obtains a negative result in step 2. Meanwhile, in a case where an attribute name of a document is included in the elements of the attribute group registered in step 1, the processor 31 obtains a positive result in step 2.

In a case where a negative result is obtained in step 2, the processor 31 notifies the user terminal 20 (see FIG. 1) about completion of registration through the function of the registration completion notification unit 313 (step 4).

Meanwhile, in a case where a positive result is obtained in step 2, the processor 31 performs grouping processing through the function of the attribute group management unit 312 (step 3). Then, the processor 31 notifies the user terminal 20 about completion of registration (step 4).

In the grouping processing according to the present exemplary embodiment, an attribute group and a folder including a document whose attribute name is included in elements of the attribute group are associated. By associating the attribute group and the folder, documents having attribute names that are elements of the attribute group are included in a result of a search in a case where any of the attribute names that are the elements of the attribute group is given as a search query.

In the present exemplary embodiment, the attribute group and the folder ID are associated as illustrated in FIG. 6.

Although a single attribute group is associated with a single folder in the present exemplary embodiment, a single attribute group may be associated with plural folders.

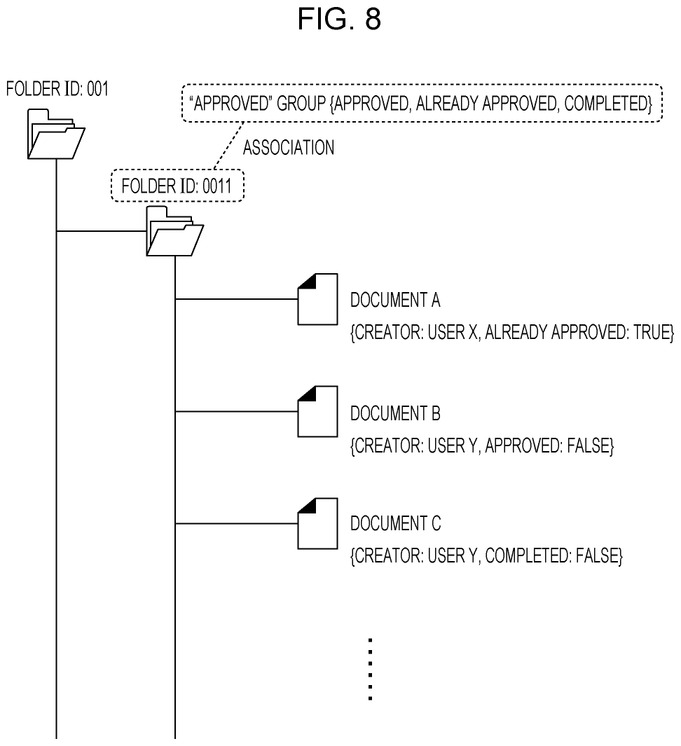

FIG. 8 is a view for explaining a relationship between a folder and an attribute group after grouping processing according to the first exemplary embodiment. In FIG. 8, parts corresponding to those in FIG. 4 are given corresponding reference signs.

In FIG. 8, the folder given the folder ID “0011” and an “APPROVED” group, which is an attribute group, are associated. “APPROVED”, which is a representative value, is used as a group name.

The “APPROVED” group includes, as elements thereof, attribute names “ALREADY APPROVED”, “APPROVED”, and “COMPLETED” given to the document A, document B, and document C associated with the folder given the folder ID “0011”.

### Search for Document

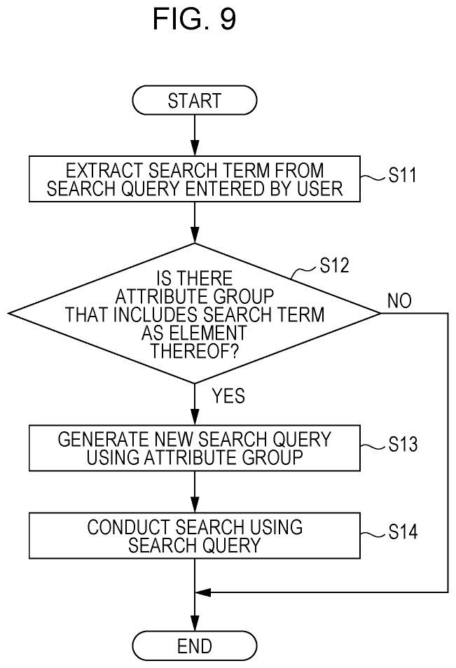

FIG. 9 is a flowchart for explaining an example of processing operation concerning a search for a document executed by the shared server 30 (see FIG. 1) used in the first exemplary embodiment. In FIG. 9, the symbol “S” represents a step.

In the search for a document, the user enters a search query by operating the user terminal 20 (see FIG. 1). The entered search query is given to the shared server 30.

Upon receipt of the search query, the processor 31 (see FIG. 2) extracts a search term from the search query entered by the user (step 11).

Next, the processor 31 determines whether or not there is an attribute group whose elements include the search term (step 12). For example, the processor 31 determines whether or not the extracted search term is included in the “APPROVED” group. The number of attribute groups for which it is determined whether or not elements thereof include the search term may be more than one.

In a case where a positive result is obtained in step 12, the processor 31 generates a new search query using the attribute group (step 13). In the present exemplary embodiment, the processor 31 generates a new search query in which the attribute names belonging to the attribute group are written in parallel.

After step 13 or after a negative result is obtained in step 12, the processor 31 conducts a search using the search query (step 14).

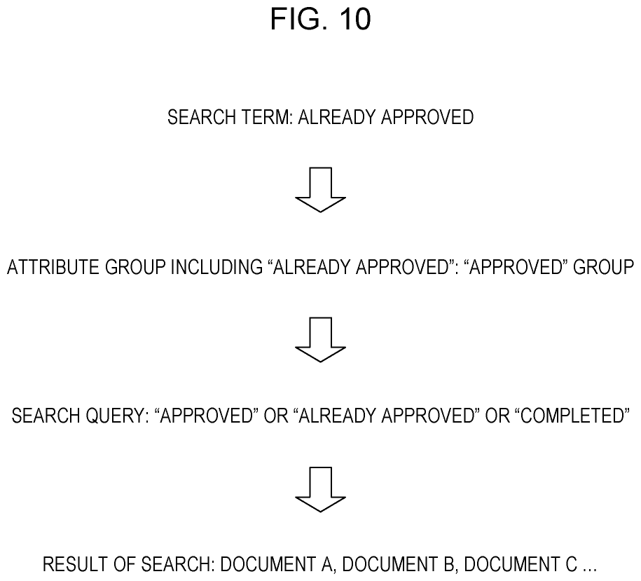

FIG. 10 is a view for explaining an example of a process of conducting a search according to the first exemplary embodiment.

As described above, first, the search term is extracted. In FIG. 10, “APPROVED” is extracted in FIG. 10.

Next, an attribute group including the extracted “APPROVED” is searched for. In this example, the “APPROVED” group is found. The elements of the “APPROVED” group are “APPROVED”, “ALREADY APPROVED”, and “COMPLETED”.

Accordingly, the search query is rewritten into “APPROVED” or “ALREADY APPROVED” or “COMPLETED”.

As a result of use of the rewritten search query, not only the document A given the attribute name “ALREADY APPROVED”, but also the documents B and C given the attribute names having similar meanings are included in a result of the search.

As described above, in a case where any user can freely give attribute names to documents to be searched, a user can acquire relevant documents as a result of a search just by designating an attribute name which the user knows even if the user knows only one or some of attribute names having similar meanings.

### Second Exemplary Embodiment

Although a case where attribute names of documents stored in the document DB 331 (see FIG. 2) remain unchanged from a time of registration is assumed in the above exemplary embodiment, the present exemplary embodiment discusses a case where a representative value of an attribute group is added to attribute names of relevant documents.

### Registration of Attribute Group

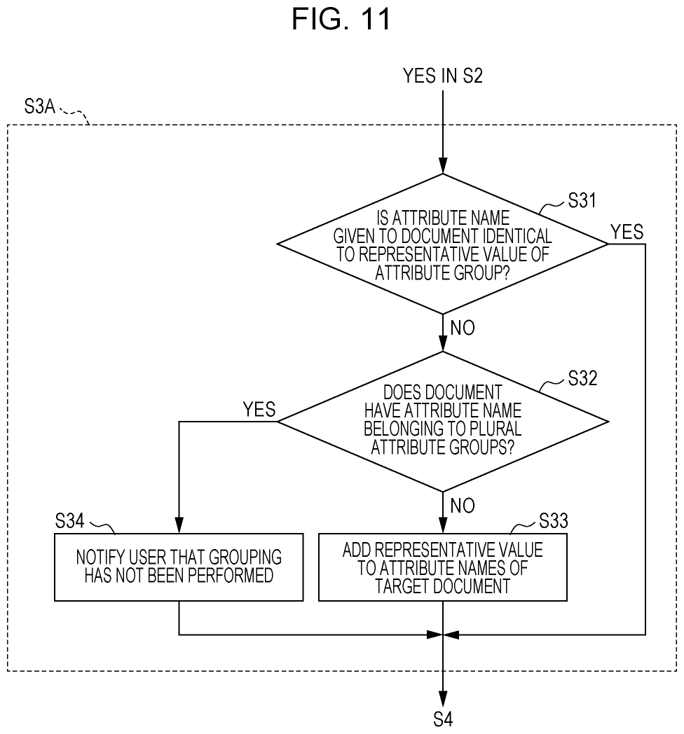

FIG. 11 is a flowchart for explaining an example of grouping processing in processing operation concerning registration of an attribute group performed by a shared server 30 (see FIG. 1) used in the second exemplary embodiment. In FIG. 11, parts corresponding to those in FIG. 7 are given corresponding reference signs.

Except for the grouping processing, the processing operation is similar to the processing operation of FIG. 7.

The grouping processing illustrated in FIG. 11 is step 3A. Step 3A is performed in a case where a positive result is obtained in step 2 (see FIG. 7).

First, the processor 31 determines whether or not an attribute name given to a document is identical to a representative value of an attribute group (step 31). In a case where an attribute name given to a document is identical to the representative value of the attribute group, a positive result is obtained in step 31. In a case where an attribute name given to a document is different from the representative value of the attribute group, a negative result is obtained in step 31.

A processor 31 does not need to perform the grouping processing according to the present exemplary embodiment on a document for which a positive result is obtained in step 31. Therefore, the processor 31 proceeds to step 4 as for the document for which a positive result is obtained in step 31.

Meanwhile, in a case where a negative result is obtained in step 31, the processor 31 determines whether or not the document has attribute names belonging to plural attribute groups (step 32).

In a case where a negative result is obtained in step 32, the processor 31 adds the representative value to the attribute names of the target document (step 33). In this way, the document is associated with the specific attribute group.

Meanwhile, in a case where a positive result is obtained in step 32, the processor 31 notifies a user that the grouping processing has not been performed (step 34). In this case, the user individually considers an attribute name to be given to the document.

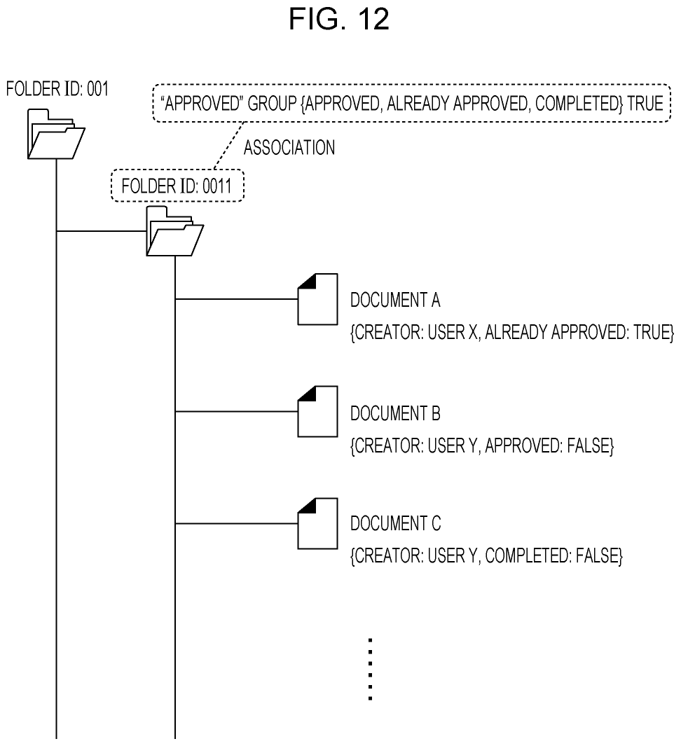

FIG. 12 is a view for explaining a state of a middle stage of the grouping processing according to the second exemplary embodiment. In FIG. 12, parts corresponding to those in FIG. 8 are given corresponding reference signs.

In FIG. 12, an “APPROVED” group is associated with a folder given a folder ID “0011”. Note that an update flag of the “APPROVED” group is “TRUE”, which indicates that the “APPROVED” group is a target of grouping processing. In the stage of FIG. 12, there is no association between the “APPROVED” group and a document.

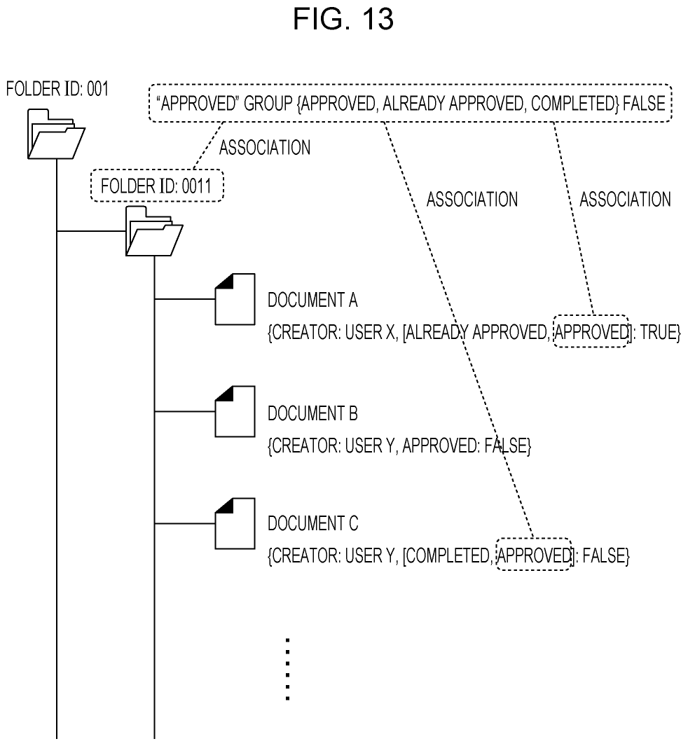

FIG. 13 is a view for explaining a state after completion of the grouping processing according to the second exemplary embodiment. In FIG. 13, parts corresponding to those in FIG. 12 are given corresponding reference signs.

In FIG. 13, a representative value “APPROVED” is added to documents A and C other than a document B given the same attribute name as the representative value of the “APPROVED” group. As a result, the representative value of the attribute group is included in the documents given attribute names having similar meanings.

### Search for Document

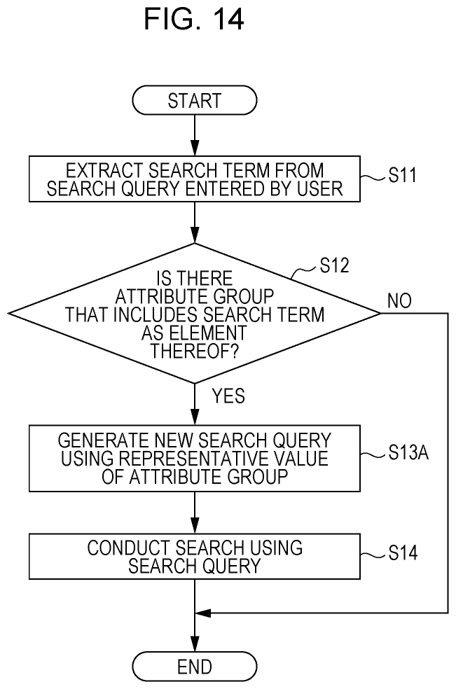

FIG. 14 is a flowchart for explaining an example of processing operation concerning a search for a document performed by the shared server 30 (see FIG. 1) used in the second exemplary embodiment. In FIG. 14, parts corresponding to those in FIG. 9 are given corresponding reference signs.

Also in the present exemplary embodiment, a user enters a search query by operating a user terminal 20 (see FIG. 1).

Upon receipt of the search query, the processor 31 (see FIG. 2) extracts a search term from the search query entered by the user (step 1).

Next, the processor 31 determines whether or not there is an attribute group including the search term as an element thereof (step 12). For example, it is determined whether or not the extracted search term is included in the “APPROVED” group. The number of attribute groups for which it is determined whether or not elements thereof include the search term may be more than one.

In a case where a positive result is obtained in step 12, the processor 31 generates a new search query using a representative value of the attribute group (step 13A).

In the present exemplary embodiment, in a case where the search term of the search query is identical to the representative value of the attribute group, the entered search term is used as it is, but in a case where the search term of the search query is different from the representative value of the attribute group, the search term is rewritten into the representative value.

After the end of step 13A or after a negative result is obtained in step 12, the processor 31 conducts a search using the search query (step 14).

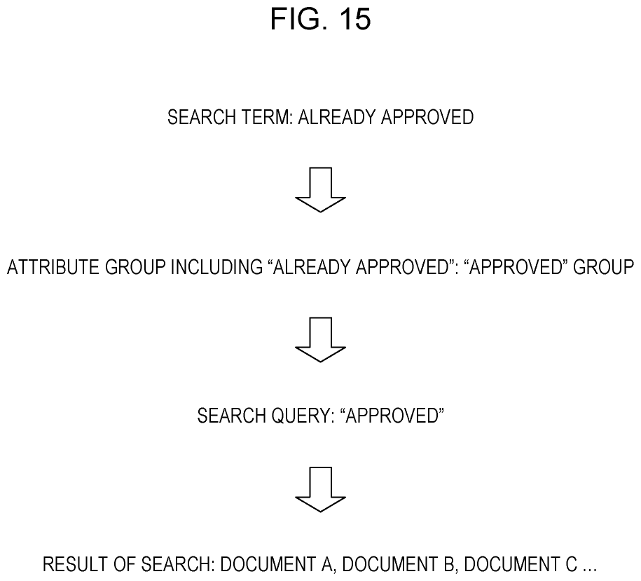

FIG. 15 is a view for explaining a process of conducting a search according to the second exemplary embodiment.

As described above, first, a search term is extracted. In FIG. 15, “ALREADY APPROVED” is extracted.

Next, an attribute group including the extracted “ALREADY APPROVED” is searched for. In this example, the “APPROVED” group is found. Elements of the “APPROVED” group are “APPROVED”, “ALREADY APPROVED”, and “COMPLETED”.

In the present exemplary embodiment, the search query is rewritten into “APPROVED”, which is the representative value of the “APPROVED” group.

As a result of use of the rewritten search query, not only the document A given the attribute name “ALREADY APPROVED”, but also the documents B and C given attribute names having similar meanings are included in a result of the search. This is because “APPROVED” is included in attribute names of the documents in the present exemplary embodiment.

As described above, in a case where any user can freely give attribute names to documents to be searched, a user can acquire relevant documents as a result of a search just by designating an attribute name which the user knows even if the user knows only one or some of attribute names having similar meanings.

In the present exemplary embodiment, a search may be conducted by using a search query including three attribute names “APPROVED”, “ALREADY APPROVED”, and “COMPLETED”, which are elements of the “APPROVED” group, as in the first exemplary embodiment.

### Third Exemplary Embodiment

In the present exemplary embodiment, a case where attribute names of documents are substituted by a representative value of an attribute group is described. The present exemplary embodiment is a modification of the second exemplary embodiment.

### Registration of Attribute Group

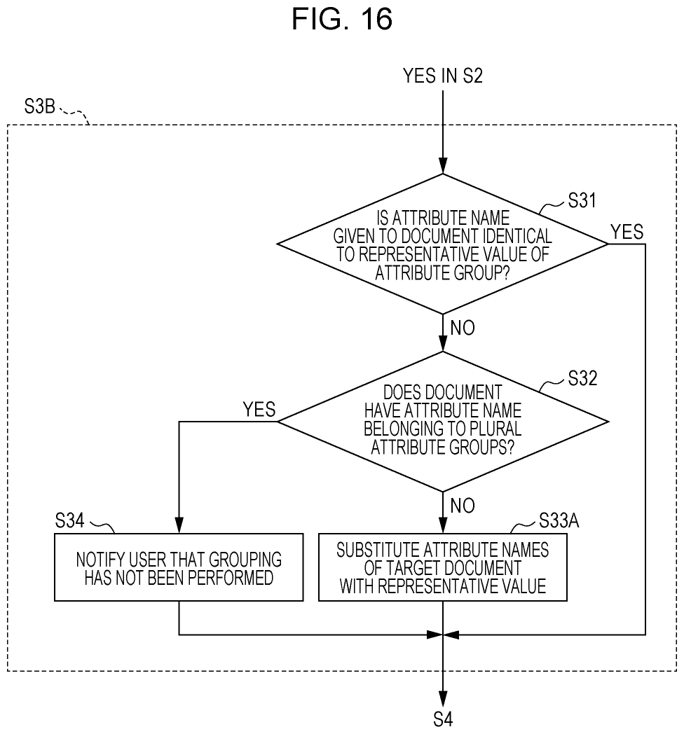

FIG. 16 is a flowchart for explaining an example of grouping processing in processing operation concerning registration of an attribute group performed by a shared server 30 (see FIG. 1) used in the third exemplary embodiment. In FIG. 16, parts corresponding to those in FIG. 11 are given corresponding reference signs.

Except for the grouping processing, the processing operation is similar to the processing operation of FIG. 7.

The grouping processing illustrated in FIG. 16 is step 3B. Step 3B is performed in a case where a positive result is obtained in step 2 (see FIG. 7).

First, a processor 31 determines whether or not an attribute name given to a document is identical to a representative value of an attribute group (step 31). In a case where an attribute name given to a document is identical to the representative value of the attribute group, a positive result is obtained in step 31. In a case where an attribute name given to a document is different from the representative value of the attribute group, a negative result is obtained in step 31.

The processor 31 does not need to perform the grouping processing according to the present exemplary embodiment on a document for which a positive result is obtained in step 31. Therefore, the processor 31 proceeds to step 4 as for the document for which a positive result is obtained in step 31.

Meanwhile, the processor 31 determines whether or not a document for which a negative result is obtained in step 31 has attribute names belonging to plural attribute groups (step 32).

In a case where a negative result is obtained in step 32, the processor 31 substitutes the attribute names of the target document with the representative value (step 33A). In this way, the document is associated with the specific attribute group. A difference from the second exemplary embodiment is that the number of attribute names does not increase and that the attribute names given by a user are deleted from the document.

Meanwhile, in a case where a positive result is obtained in step 32, the processor 31 notifies the user that the grouping processing has not been performed (step 34). In this case, the user individually considers an attribute name to be given to the document.

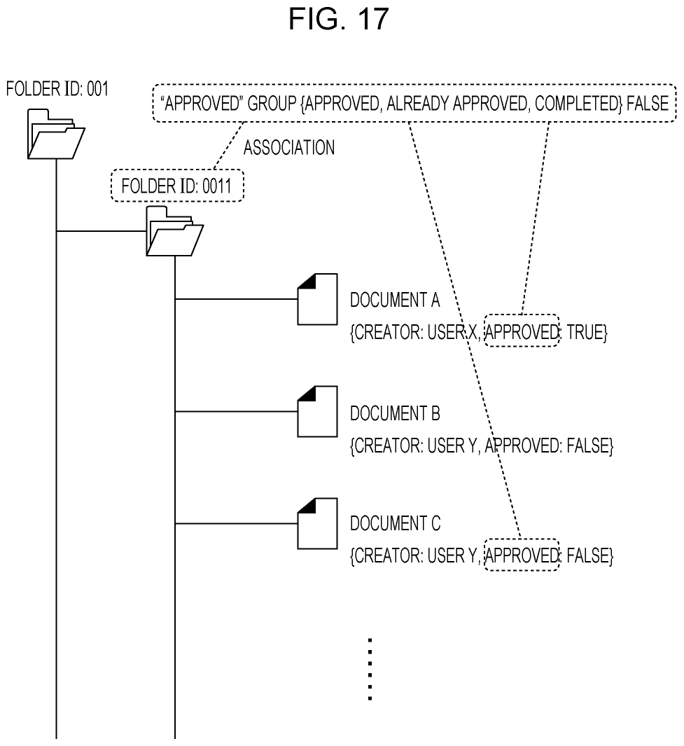

FIG. 17 is a view for explaining a state after completion of the grouping processing according to the third exemplary embodiment. In FIG. 17, parts corresponding to those in FIG. 13 are given corresponding reference signs.

Note that a state of a middle stage of the grouping processing is identical to that in FIG. 12 described in the second exemplary embodiment.

In FIG. 17, attribute names of documents A and C other than a document B given an attribute name identical to the representative value of the “APPROVED” group are substituted with “APPROVED”, which is the representative value of the attribute group. In the present exemplary embodiment, all attribute names of documents whose attribute names belong to the same attribute group are unified into the same representative value.

### Search for Document

Processing operation concerning a search for a document in the present exemplary embodiment is identical to the processing operation described in the second exemplary embodiment. That is, the processing operation illustrated in FIG. 14 is used in the present exemplary embodiment. Specifically, an actual search is conducted by using the representative value of the attribute group. Accordingly, a process of conducting a search is identical to that in FIG. 15 described in the second exemplary embodiment.

Accordingly, in a case where an element of the attribute group is included in a search term, the documents B and C having attribute names that match the entered search term are also included in a result of the search, even in a case where attribute names of documents have term inconsistency.

However, in the present exemplary embodiment, an attribute name of a document is rewritten irrespective of an intention of a user who registered the attribute name. Therefore, the user may be surprised of a difference from the attribute name which the user gave when checking the attribute of the document.

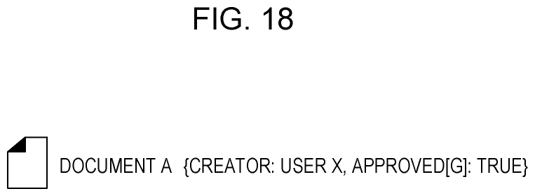

FIG. 18 is a view for explaining a display example of attributes of a document according to the exemplary embodiment. In FIG. 18, the document A is illustrated.

A [G] mark is added to the attribute name of the document A unlike the attribute names described above. The [G] mark indicates that the attribute name has been substituted with the representative value of the attribute group. Therefore, the user who sees “APPROVED [G]” knows the fact that the attribute name has been substituted with the representative value.

As described above, in a case where any user can freely give attribute names to documents to be searched, a user can acquire relevant documents as a result of a search just by designating an attribute name which the user knows even if the user knows only one or some of attribute names having similar meanings.

### Fourth Exemplary Embodiment

In the above exemplary embodiments, it is assumed that an attribute group and a representative value thereof are given in advance. In the present exemplary embodiment, a case where a shared server 30 (see FIG. 1) has a function of automatically generating an attribute group and a representative value thereof is described.

### Configuration of System

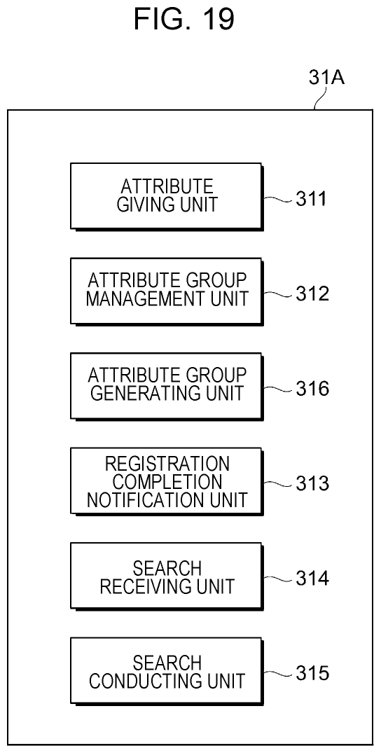

FIG. 19 is a view for explaining some of functions realized by a processor 31A of the shared server 30 used in the fourth exemplary embodiment. In FIG. 19, parts corresponding to those in FIG. 3 are given corresponding reference signs.

The fourth exemplary embodiment is different from the other exemplary embodiments described above in that the processor 31A illustrated in FIG. 19 further includes an attribute group generating unit 316.

The attribute group generating unit 316 sequentially reads out documents stored in a document DB 331 (see FIG. 2) and extracts attribute names given to the documents. Furthermore, the attribute group generating unit 316 generates an attribute group by gathering the extracted attribute names.

Whether or not attribute names have similar meanings is determined, for example, by using a dictionary of synonyms prepared in advance. The dictionary of synonyms may be edited manually or may be generated by machine learning.

In the present exemplary embodiment, the attribute group generating unit 316 gathers attribute names having similar meanings on a folder basis. This is because it is estimated that contents of documents belonging to the same folder have high relevance. Furthermore, this is to exclude a document of low relevance from a result of a search.

### Example Document DB

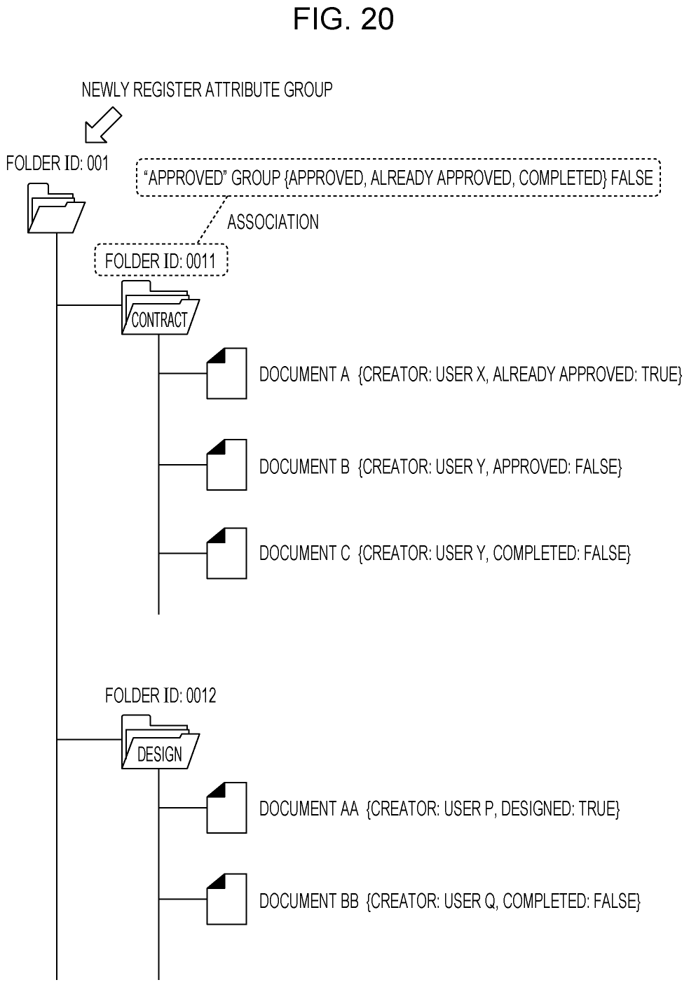

FIG. 20 is a view for explaining an example of a configuration of the document DB 331 (see FIG. 2). The document DB 331 used in the present exemplary embodiment stores therein documents in association with folders corresponding to nodes of a tree structure.

In FIG. 20, an ID of a folder located at a root is “001”, and two folders are located at positions of child nodes of the root. One of the two folders is a “CONTRACT” folder given an ID “0011”, and the other one of the two folders is a “DESIGN” folder given an ID “0012”.

The “CONTRACT” folder is an example of a first group, and the “DESIGN” folder is an example of a second group.

Two documents, that is, a document AA and a document BB are stored in the “DESIGN” folder illustrated in FIG. 20. Note that an attribute value corresponding to “CREATOR” of the document AA is “USER P”, and an attribute value corresponding to “DESIGNED” of the document AA is “TRUE”. An attribute value corresponding to “CREATOR” of the document BB is “USER Q”, and an attribute value corresponding to “COMPLETED” of the document BB is “FALSE”.

Although a document C and the document BB are illustrated as documents having an attribute name “COMPLETED” in the example of FIG. 20, the document C may be included in both of the “CONTRACT” folder and the “DESIGN” folder.

In FIG. 20, an “APPROVED” group, which is an attribute group, is already associated with the “CONTRACT” folder. An update flag of the “APPROVED” group is “FALSE”.

In FIG. 20, an attribute group is newly registered in the root folder. In this case, the attribute group generating unit 316 acquires five documents from the two folders located at the child nodes and generates a group of attribute names having similar meanings among attribute names given to the documents.

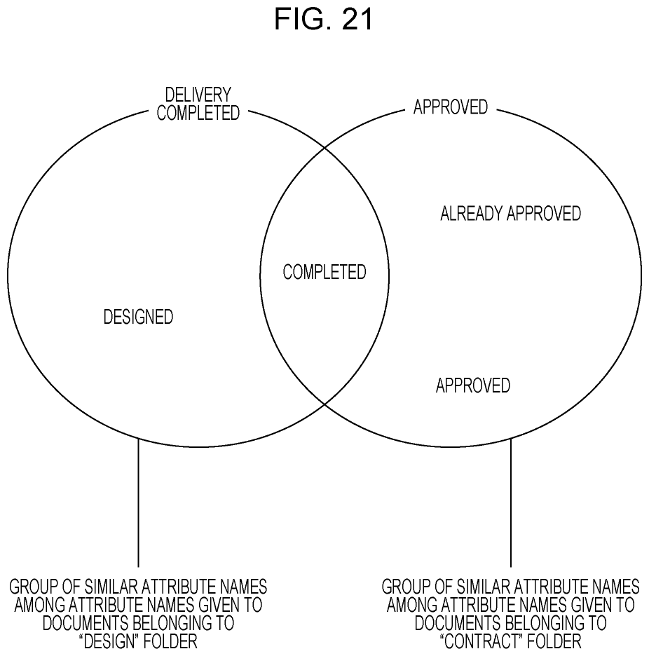

FIG. 21 is a view for explaining an example of generation of an attribute group according to the fourth exemplary embodiment.

The example of the attribute group illustrated in FIG. 21 is generated from the five documents belonging to the root folder illustrated in FIG. 20.

As illustrated in FIG. 21, the attribute names given to the five documents can be classified into two attribute groups. One of the two attribute groups is an “APPROVED” group described also in the other exemplary embodiments, and the other one of the two attribute groups is a “DELIVERY COMPLETED” group. Although a representative value may be selected from among the attribute names which are elements of the group, the representative value is given by a user in advance in the example of FIG. 21.

In FIG. 21, an attribute name “COMPLETED” belongs to the two attribute groups. That is, the attribute name “COMPLETED” exists in an overlapping part of the two attribute groups. In this case, a positive result is obtained, for example, in step 32 (see FIG. 11).

In this case, there is a problem about with which attribute group a document given the attribute name “COMPLETED” is to be associated.

Both of the document C and the document BB given the attribute name “COMPLETED” may be associated with both of the “APPROVED” group and the “DELIVERY COMPLETED” group.

However, in a case where a single attribute name is associated with plural attribute groups, there is a possibility that not only documents intended by a user, but also a lot of irrelevant documents are included in a result of a search. For example, in a case where a user wants to find the document AA and the document BB by a search, a document A, a document B, and the document C are also included in a result of a search.

In view of this, the processor 31A (see FIG. 19) according to the present exemplary embodiment performs grouping processing in accordance with a predetermined rule. That is, the processor 31A performs processing for associating an attribute group and a document. A specific example of the predetermined rule is described below.

### Registration of Attribute Group

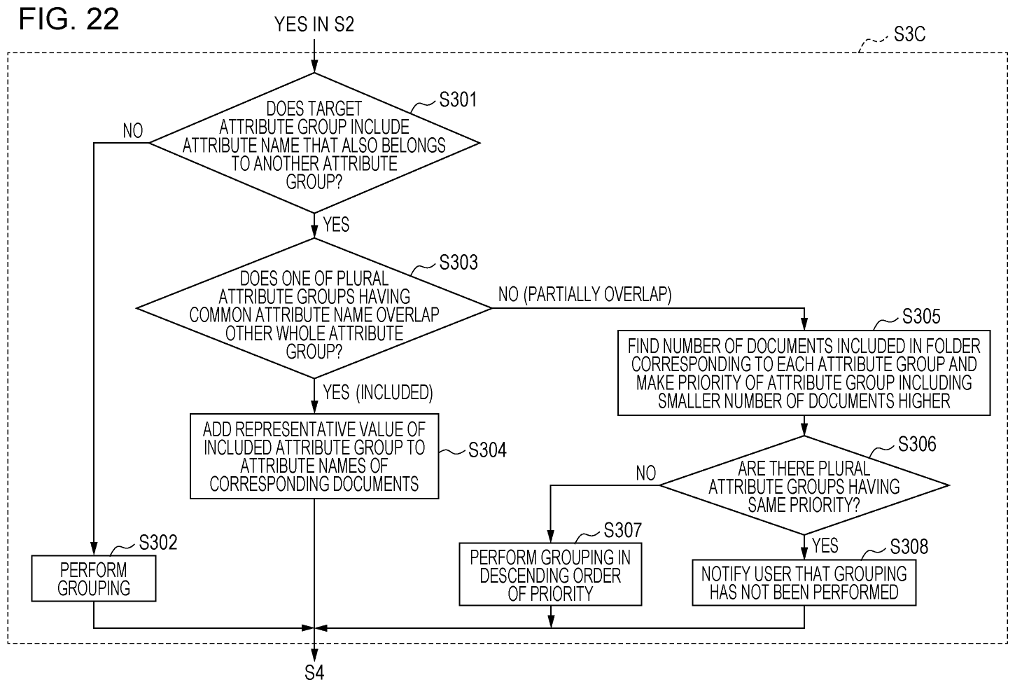

FIG. 22 is a flowchart for explaining an example of grouping processing in processing operation concerning registration of an attribute group performed by the shared server 30 (see FIG. 1) used in the fourth exemplary embodiment. In FIG. 22, parts corresponding to those in FIG. 7 are given corresponding reference signs.

Except for the grouping processing, the processing operation is similar to the processing operation of FIG. 7.

The grouping processing illustrated in FIG. 22 is step 3C. Step 3C is performed in a case where a positive result is obtained in step 2 (see FIG. 7).

First, the processor 31 determines whether or not a target attribute group includes an attribute name that also belongs to another attribute group (step 301). Specifically, the processor 31 determines whether or not the attribute group includes an attribute name corresponding to “COMPLETED” in FIG. 21.

In a case where the target attribute group includes an attribute name that meets the condition of the determining process, a positive result is obtained in step 301. Meanwhile, in a case where the target attribute group includes no attribute name that meets the condition of the determining process, a negative result is obtained in step 301.

In a case where a negative result is obtained in step 301, the processor 31 performs grouping of the target attribute group and a document having an attribute name that is an element of the attribute group (step 302). The grouping is performed by any of the methods described in the first to third exemplary embodiments.

In a case where a positive result is obtained in step 301, the processor 31 determines whether or not one of the plural attribute groups having the common attribute name overlaps the other whole attribute group (step 303).

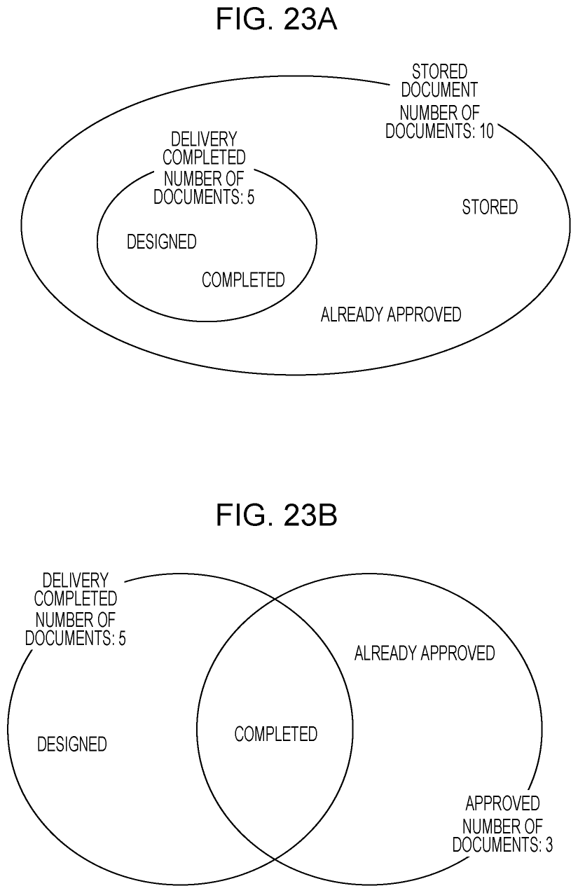

FIGS. 23A and 23B are views for explaining a relationship between plural attribute groups. FIG. 23A illustrates a relationship in which one attribute group includes the other whole attribute group, and FIG. 23B illustrates a relationship in which one attribute group and the other attribute group partially overlap each other, but one attribute group does not include the other attribute group.

In the example of FIG. 23A, an attribute group “STORED DOCUMENT” includes the whole attribute group “DELIVERY COMPLETED”. In the example of FIG. 23B, the two attribute groups overlap each other only in an attribute name “COMPLETED”.

See FIG. 22 again.

In a case where a positive result is obtained in step 303, the processor 31 adds a representative value of an included attribute group to attribute names of corresponding documents (step 304). In the example of FIG. 23A, attribute names “DESIGNED” and “COMPLETED” are associated with the five documents of the folder associated with the “DELIVERY COMPLETED” group.

This example corresponds to the grouping processing described in the second exemplary embodiment. Note that the method described in the first exemplary embodiment or the method described in the third exemplary embodiment may also be used as a method of the grouping processing.

Meanwhile, in a case where a negative result is obtained in step 303, the processor 31 finds the number of documents included in a folder corresponding to each attribute group and makes a priority of an attribute group including a smaller number of documents higher (step 305).

Next, the processor 31 determines whether or not there are plural attribute groups having the same priority (step 306).

In a case where plural attribute groups do not have the same priority, the processor 31 obtains a negative result in step 306 and performs grouping in a descending order of priority (step 307).

Specifically, an attribute name is associated with an attribute group corresponding to a smaller number of documents. In the example of FIG. 23B, the attribute name “COMPLETED” is associated with the “APPROVED” group.

In a case where there are plural attribute groups having the same priority, the processor 31 obtains a positive result in step 306 and notifies the user that grouping has not been performed (step 308). In this case, the user considers an attribute name to be given to the document.

In the present exemplary embodiment, an attribute name belonging to plural attribute groups is associated with an attribute group corresponding to a folder including a smaller number of documents.

As a result, the number of documents presented to a user as a result of a search using a given search term is smaller than that in a case where the attribute name is associated with another attribute group.

In a case where the number of presented documents is too large, it tends to take a long time to find a target document. However, since a document is associated with an attribute group associated a smaller number of documents in the present exemplary embodiment, the number of documents included in a result of a search using an attribute group becomes smaller, and a target document can be found in a shorter time.

Attribute groups including the same attribute name and whose corresponding folders include documents that partially or entirely overlap can be regarded as similar attribute groups. In view of this, similar attribute groups may be stored in the attribute group DB 332 in association with each other.

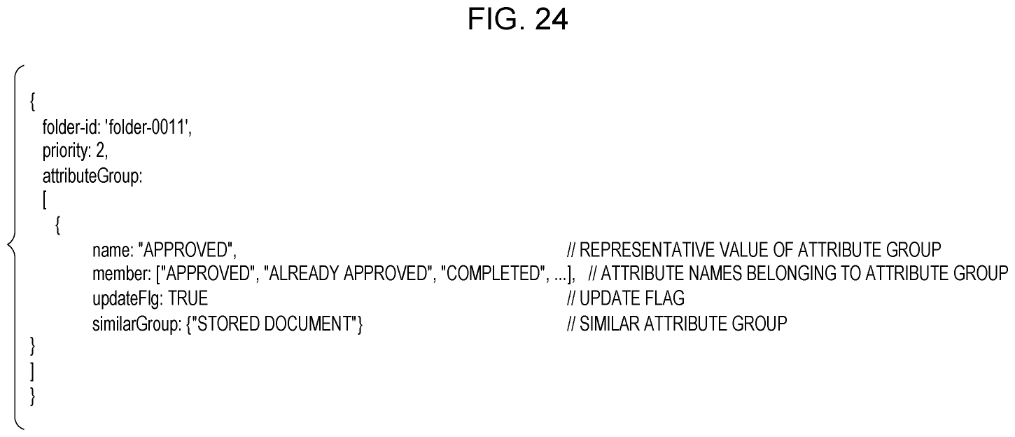

FIG. 24 illustrates an example of a structure of the “APPROVED” group stored in the attribute group DB 332. in FIG. 24, parts corresponding to those in FIG. 6 are given corresponding reference signs.

In FIG. 24, “APPROVED”, “ALREADY APPROVED”, and “COMPLETED” are illustrated as attribute names belonging to the attribute group. Furthermore, an update flag of the attribute group is set to “TRUE”. The “APPROVED” group and the “STORED DOCUMENT” group include the same attribute name “ALREADY APPROVED” and whose corresponding folders include documents that partially overlap and are therefore similar attribute groups.

A difference between the structure of the attribute group illustrated in FIG. 24 and the structure of the attribute group illustrated in FIG. 6 is that there is an item “Similar Group” concerning a similar attribute group in FIG. 24. By thus storing a similar attribute group, a user who conducted a search using a representative value of the “APPROVED” group” or an attribute name belonging to the “APPROVED” group may be provided with information indicating that there is a similar attribute group “STORED DOCUMENT” to prompt the user to conduct a search again.

Furthermore, the structure of the attribute group illustrated in FIG. 24 has an item “Priority” unlike the structure of the attribute group illustrated in FIG. 6. That is, a value of the priority described above may be stored in the attribute group DB 332 in association with an attribute group. In a case where a folder that newly becomes a target of grouping processing includes plural folders in which priorities determined before are stored and a relationship among the priorities is not changed, processing for determining priorities again may be omitted.

### Fifth Exemplary Embodiment

In the present exemplary embodiment, a case where a shared server 30 (see FIG. 1) has a function of assisting a user in giving an attribute name is described.

### Configuration of System

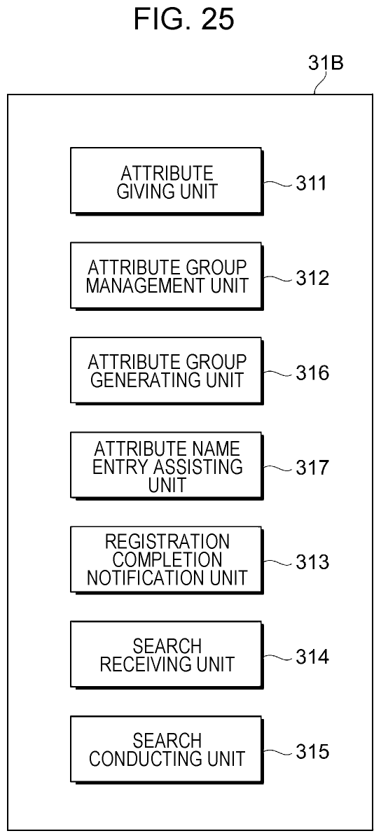

FIG. 25 is a view for explaining some of functions realized by a processor 31B of the shared server 30 used in the fifth exemplary embodiment. In FIG. 25, parts corresponding to those in FIG. 19 are given corresponding reference signs.

The fifth exemplary embodiment is different from the fourth exemplary embodiment in that the processor 31B illustrated in FIG. 25 further includes an attribute name entry assisting unit 317.

The attribute name entry assisting unit 317 assists entry of an attribute name to be given to a new document uploaded to the shared server 30.

The attribute name entry assisting unit 317 according to the present exemplary embodiment rearranges existing attribute groups in a descending order of user's use frequency and presents representative values thereof to the user as candidates of an attribute name. This suppresses occurrence of term inconsistency among attribute names. The user's use frequency is stored as a history of use frequency.

As the user's use frequency, for example, a rate of entry for a search or a rate of giving an attribute name is used. The rate of entry is a quotient obtained by dividing a total number of user's searches by the number of times of entry as a search term. The rate of giving an attribute name is a quotient obtained by dividing a total number of times the user gave an attribute name by the number of times a specific attribute name was given.

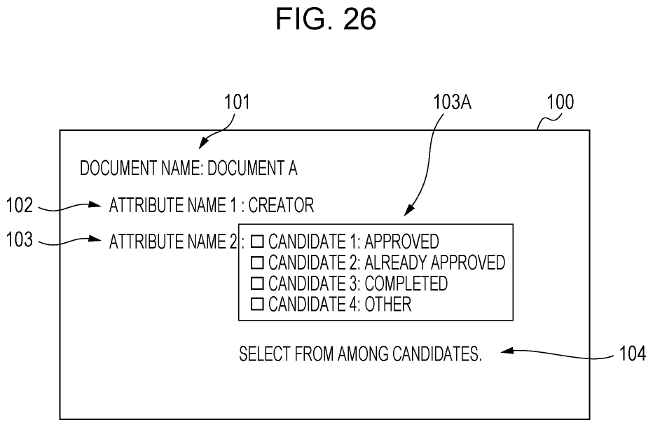

FIG. 26 illustrates an example of a screen 100 for attribute names displayed on a display of a user terminal 20 (see FIG. 1) when a new document is registered.

On the screen 100 illustrated in FIG. 26, “DOCUMENT A” is displayed as a document name 101, “CREATOR” is displayed as a first attribute name 102, and four candidates 103A are displayed as a second attribute name 103.

In FIG. 26, the first candidate is “APPROVED”, which is a representative name, the second candidate is “ALREADY APPROVED”, the third candidate is “COMPLETED”, and the fourth candidate is “OTHER”. The order of the candidates is decided on the basis of the rate of entry or the rate of giving an attribute name. In this example, user's use frequency of the candidate 1 is highest, user's use frequency of the candidate 2 is second highest, and user's use frequency of the candidate 3 is third highest.

Note that an explanatory text 104 prompting a user's operation is displayed below the candidates 103A.

By presenting the screen 100 illustrated in FIG. 26 to a user who uploads a document, term inconsistency among attribute names becomes less likely to occur.

### Other Exemplary Embodiments

Although exemplary embodiments of the present disclosure have been described above, the technical scope of the present disclosure is not limited to the scope described in the above exemplary embodiments. It is apparent from the claims that various changes or modifications to the above exemplary embodiments are also encompassed within the technical scope of the present disclosure.

Although it is assumed in the above exemplary embodiments that an attribute name is used as a search key, an attribute value may be used as a search key. Also in a case where a user freely registers an attribute value, there occurs term inconsistency, but missing of a document from a search result due to term inconsistency can be prevented by managing a group of similar attribute values. An attribute value is also an example of an attribute.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system comprising
a processor configured to
receive entry of an attribute given to a document as a search key for searching for a document, and
search for the document by using a representative value of a group including a plurality of first attributes having similar meanings as elements thereof in a case where the received search key includes any one of the first attributes, a second attribute being set as the representative value of the group.

2. The information processing system according to claim 1, wherein
the processor is configured to search for a document given the second attribute, which is the representative value of the group including the first attributes as the elements thereof.

3. The information processing system according to claim 2, wherein
the second attribute is given on a directory basis, which is used for hierarchical document management.

4. An information processing system comprising: a processor configured to
receive entry of an attribute given to a document as a search key for searching for a document, and
search for the document by using all elements of a group including a plurality of first attributes having similar meanings as elements thereof in a case where the received search key includes any one of the first attributes, a second attribute being set as the representative value of the group.

5. The information processing system according to claim 4, wherein
the processor is configured to search for a document given any one of the elements of the group including the first attributes as the elements thereof.

6. The information processing system according to claim 5, wherein
the first attributes are given by a user.

7. The information processing system according to claim 1, wherein
the processor is configured to, in a case where the second attribute is given on a directory basis, which is used for hierarchical document management, generate a group of the first attributes having similar meanings given to documents belonging to the directory and the second attribute that gives a representative value of the group.

8. The information processing system according to claim 4, wherein
the processor is configured to, in a case where the second attribute is given on a directory basis, which is used for hierarchical document management, generate a group of the first attributes having similar meanings given to documents belonging to the directory and the second attribute that gives a representative value of the group.

9. The information processing system according to claim 7, wherein
the processor is configured to, in a case where a change is made to the elements of the group, update association between the first attributes and the second attribute.

10. The information processing system according to claim 8, wherein
the processor is configured to, in a case where a change is made to the elements of the group, update association between the first attributes and the second attribute.

11. The information processing system according to claim 1, wherein
the processor is configured to, in a case where a user gives the first attributes to documents, present the second attribute on a basis of use frequency.

12. The information processing system according to claim 4, wherein
the processor is configured to, in a case where a user gives the first attributes to documents, present the second attribute on a basis of use frequency.

13. The information processing system according to claim 11, wherein
the processor is configured to present the first attributes in descending order of frequency of use in a search key.

14. The information processing system according to claim 12, wherein
the processor is configured to present the first attributes in descending order of frequency of use in a search key.

15. The information processing system according to claim 1, wherein
the processor is configured to, in a case where there is a first attribute belonging to both of a first group, which is the group, and a second group, update association between the first attributes and the second attribute in accordance with a predetermined rule.

16. The information processing system according to claim 4, wherein
the processor is configured to, in a case where there is a first attribute belonging to both of a first group, which is the group, and a second group, update association between the first attributes and the second attribute in accordance with a predetermined rule.

17. The information processing system according to claim 15, wherein
the processor is configured to, in a case where the whole first group is included in the second group, add the second attribute, which gives the representative value of the first group, to elements of the second group.

18. The information processing system according to claim 15, wherein
the processor is configured to, in a case where a part of the first group and a part of the second group overlap each other and one of the first and second groups does not include the other one of the first and second groups, set a first attribute in an overlapping part as an element of one of the first and second groups that includes a smaller number of elements.

19. The information processing system according to claim 15, wherein
the processor is configured to, in a case where a part of the first group and a part of the second group overlap each other and one of the first and second groups does not include the other one of the first and second groups, set a first attribute in an overlapping part as an element of one of the first and second groups whose corresponding document belongs to a lower directory.

20. A non-transitory computer readable medium storing a program causing a computer to execute a process for information processing, the process comprising:
receiving entry of an attribute given to a document as a search key for searching for a document, and
searching for the document by using a representative value of a group including a plurality of first attributes having similar meanings as elements thereof in a case where the received search key includes any one of the first attributes, a second attribute being set as the representative value of the group.
